(19) United States
(12) Patent Application Publication
(10) Pub. No.: US 2025/0377571 A1
(43) Pub. Date: Dec. 11, 2025

(54) ELECTROPHORETIC DISPLAY

(71) Applicant: E Ink Holdings Inc., Hsinchu (TW)

(72) Inventors: Wen-Yu Kuo, Hsinchu (TW); Wenchuan Wang, Hsinchu (TW); Wen Ya Chao, Hsinchu (TW); Kuang-Heng Liang, Hsinchu (TW)

(73) Assignee: E Ink Holdings Inc., Hsinchu (TW)

(21) Appl. No.: 18/921,013

(22) Filed: Oct. 21, 2024

(30) Foreign Application Priority Data
Jun. 6, 2024 (TW) 113121010

(51) Int. Cl. G02F 1/16766; G02F 1/167; G02F 1/16755

(52) U.S. Cl. CPC G02F 1/16766; G02F 1/167; G02F 1/16755

(57) ABSTRACT

An electrophoretic display includes an element array substrate and an electrophoretic display substrate. The element array substrate includes a plurality of signal lines, a plurality of common electrodes, and a plurality of pixel electrodes. A first common electrode and a second common electrode among the plurality of common electrodes are respectively disposed on opposite sides of one signal line of the plurality of signal lines. One pixel electrode among the plurality of pixel electrodes crosses the one signal line and forms a first storage capacitor and a second storage capacitor with the first common electrode and the second common electrode respectively. The electrophoretic display substrate is disposed on the element array substrate.

### CROSS-REFERENCE TO RELATED APPLICATION

This application claims the priority benefit of Taiwan application serial no. 113121010, filed on Jun. 6, 2024. The entirety of the above-mentioned patent application is hereby incorporated by reference herein and made a part of this specification.

### BACKGROUND

### Technical Field

The disclosure relates to a display, and particularly relates to an electrophoretic display.

### Description of Related Art

Displays using a pixel array design with a non-linear arrangement (for example, a triangular arrangement) can have better image quality, and a stripe pattern phenomenon on the screen is less. However, in this layout, in order to maintain a high aperture ratio of the pixels, multiple signal lines have to bypass multiple pixel electrodes, as a result, the impedance and RC loading of the signal line are increased as the length of the signal line are increased. On the other hand, if the multiple signal lines directly cross multiple pixel electrodes without bypassing the multiple pixel electrodes, although the impedance and RC loading of the signal line are low, the layout space of the storage capacitor is reduced, as a result, the size, resolution, or pixel density of the pixel array in the non-linear arrangement (such as a triangular arrangement) can have many design limitations compared with the conventional pixel array.

### SUMMARY

The disclosure provides an electrophoretic display, which can improve at least one of the above problems.

An electrophoretic display of the disclosure includes an element array substrate and an electrophoretic display substrate. The element array substrate includes multiple signal lines, multiple common electrodes, and multiple pixel electrodes. A first common electrode and a second common electrode among the plurality of common electrodes are respectively disposed on opposite sides of one signal line among the plurality of signal lines. One pixel electrode among the plurality of pixel electrodes crosses the one signal line and forms a first storage capacitor and a second storage capacitor with the first common electrode and the second common electrode respectively. The electrophoretic display substrate is disposed on the element array substrate.

In order to make the above-mentioned features and advantages of the disclosure more comprehensible, embodiments are given below and described in detail with reference to the accompanying drawings.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A, FIG. 2A, FIG. 3A, FIG. 4A, FIG. 5A, FIG. 6A, and FIG. 8 are partial top views of seven electrophoretic displays according to some embodiments of the disclosure, each of the drawings illustrates some elements and/or film layers of an element array substrate in an electrophoretic display, and an electrophoretic display substrate of the electrophoretic display is omitted in the drawings.

FIG. 1B and FIG. 1C are schematic cross-sectional views corresponding to a section line I-I′ and a section line II-II′ in FIG. 1A respectively.

FIG. 1D is a top view illustrating a first storage capacitor and a second storage capacitor in FIG. 1A.

FIG. 1E is a top view illustrating a third storage capacitor and a fourth storage capacitor in FIG. 1A.

FIG. 2B and FIG. 2C are schematic cross-sectional views corresponding to a section line III-III′ and a section line IV-IV′ in FIG. 2A respectively.

FIG. 2D is a top view illustrating the first storage capacitor and the second storage capacitor in FIG. 2A.

FIG. 2E is a top view illustrating the third storage capacitor and the fourth storage capacitor in FIG. 2A.

FIG. 3B is a schematic cross-sectional view corresponding to a cross-section line V-V′ in FIG. 3A.

FIG. 3C is a top view illustrating the first storage capacitor and the second storage capacitor in FIG. 3A.

FIG. 3D is a top view illustrating a third storage capacitor in FIG. 3A.

FIG. 4B is a schematic cross-sectional view corresponding to a section line VI-VI′ in FIG. 4A.

FIG. 4C is a top view illustrating the first storage capacitor and the second storage capacitor in FIG. 4A.

FIG. 4D is a top view illustrating the third storage capacitor and a fourth storage capacitor in FIG. 4A.

FIG. 5B is a schematic cross-sectional view corresponding to a section line VII-VII′ in FIG. 5A.

FIG. 5C is a top view illustrating the first storage capacitor and the second storage capacitor in FIG. 5A.

FIG. 5D is a top view illustrating the third storage capacitor in FIG. 5A.

FIG. 6B is a schematic cross-sectional view corresponding to a section line VIII-VIII′ in FIG. 6A.

FIG. 6C is a top view illustrating the first storage capacitor and the second storage capacitor in FIG. 6A.

FIG. 6D is a top view illustrating the third storage capacitor and the fourth storage capacitor in FIG. 6A.

FIG. 7 is a partial cross-sectional schematic view of an electrophoretic display according to some embodiments of the disclosure.

### DESCRIPTION OF THE EMBODIMENTS

Direction terms mentioned in this document, such as “upper”, “lower”, “front”, “back”, “left”, “right”, are only for reference to directions of the accompanying drawings. Therefore, the direction terms used are to illustrate, but not to limit the disclosure.

In the accompanying drawings, each of the drawings illustrates general features of methods, structures, or materials used in particular embodiments. However, the drawings should not be interpreted as defining or limiting the scope or nature encompassed by the embodiments. For example, the relative sizes, thicknesses, and locations of each film layer, region, or structure may be reduced or enlarged for clarity.

In the accompanying drawings, the same or similar elements are given the same or similar reference numerals, and redundant descriptions thereof will be omitted in the description. In addition, features in different embodiments may be combined with each other in a case where no conflict is present, and simple equivalent changes and modifications made in accordance with this specification or the scope of the appended claims are still within the scope of the disclosure.

Terms such as “first” and “second” mentioned in this specification or the scope of the appended claims are only used to name different components or distinguish different embodiments or scopes, are not used to limit the upper or lower limit on the quantity of components, and are not used to limit the order in which components are manufactured or the order in which components are disposed. In addition, an element/film layer being disposed on (or over) another element/film layer may encompass various situations, including that the element/film layer is directly disposed on (or over) the other element/film layer and two elements/film layers are in direct contact, and that the element/film layer is indirectly arranged on (or above) the other element/film layer, and there are one or more elements/film layers between the two elements/film layers.

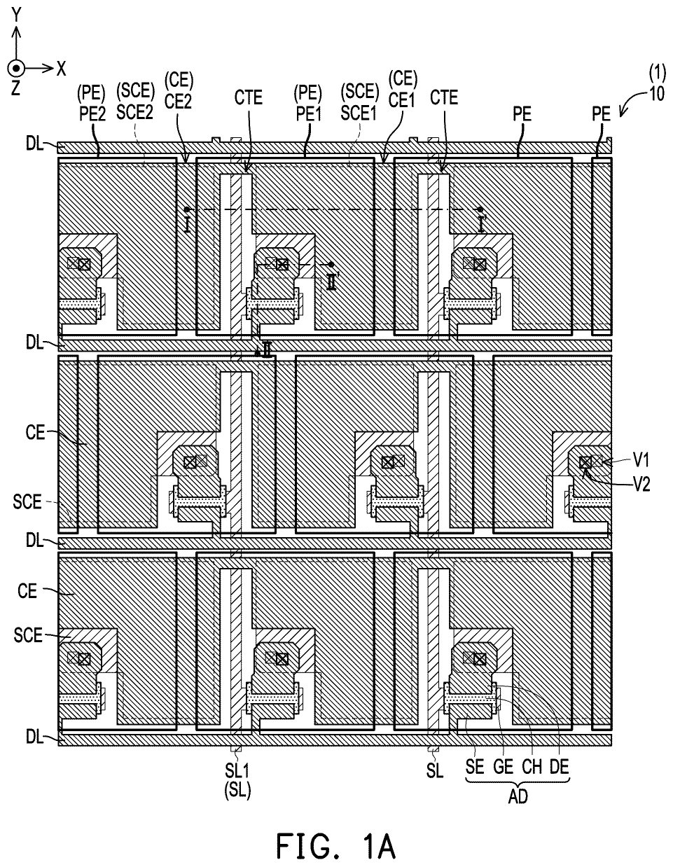

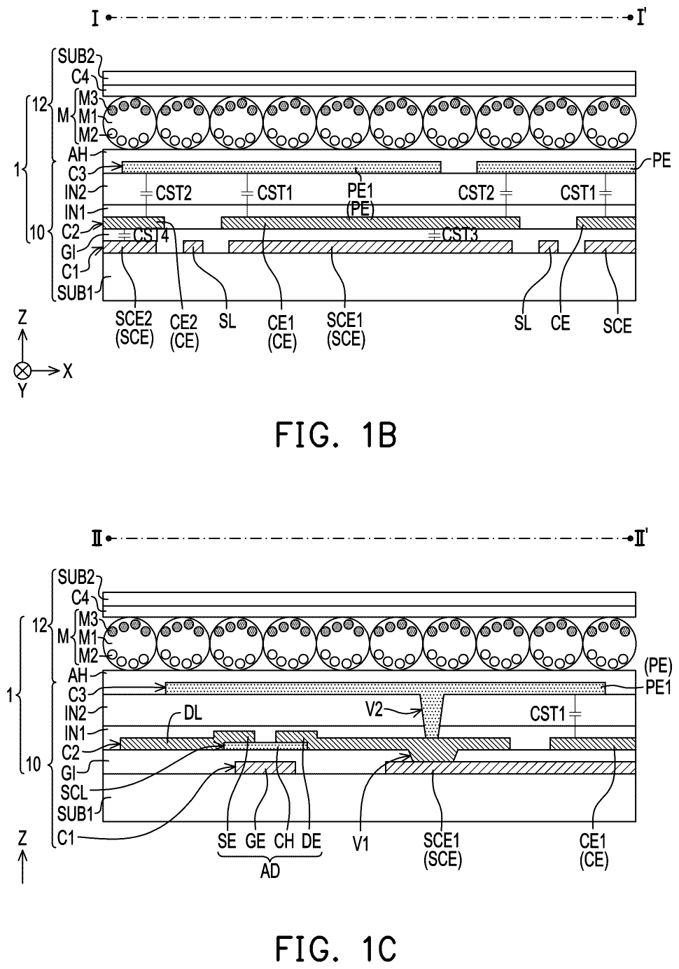

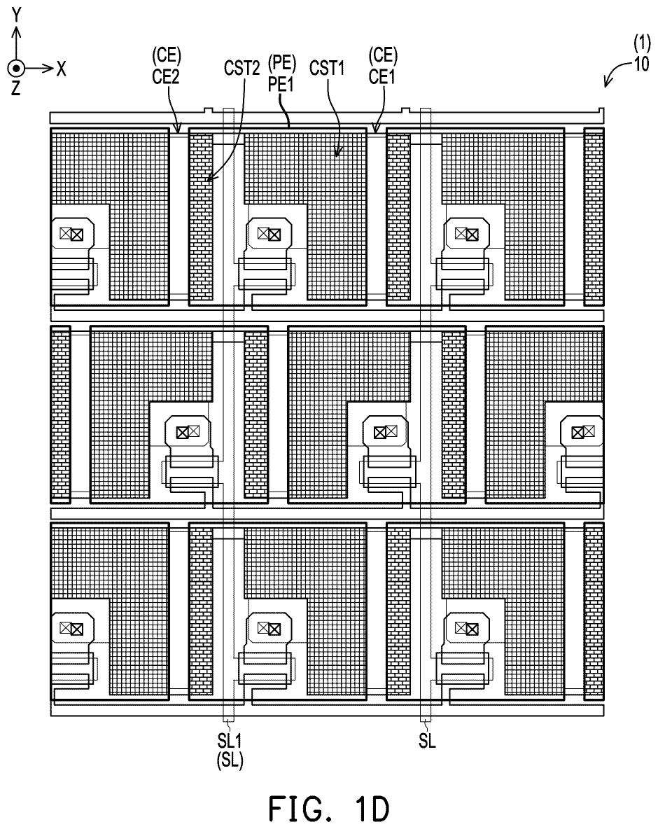

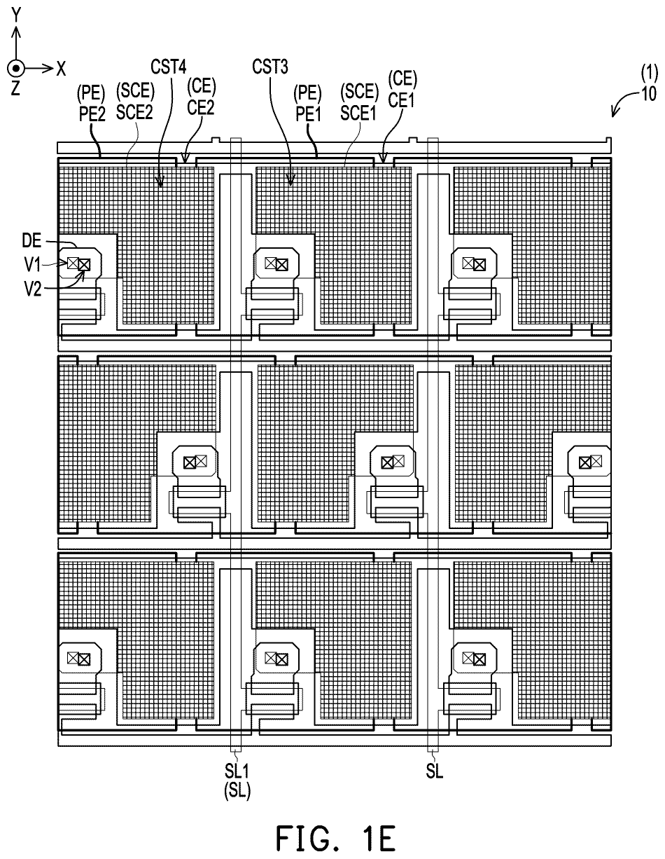

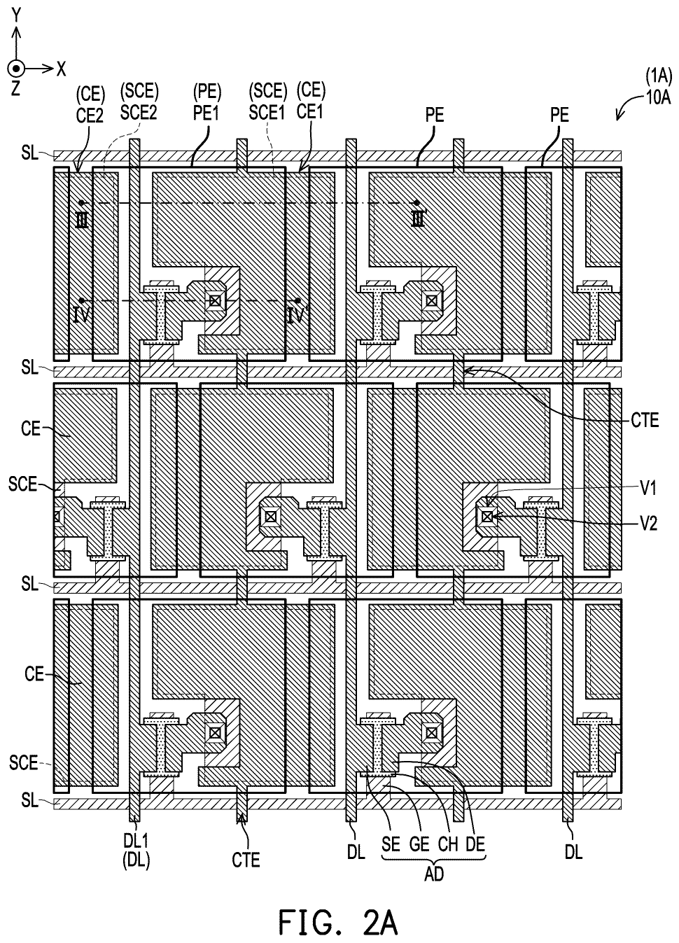

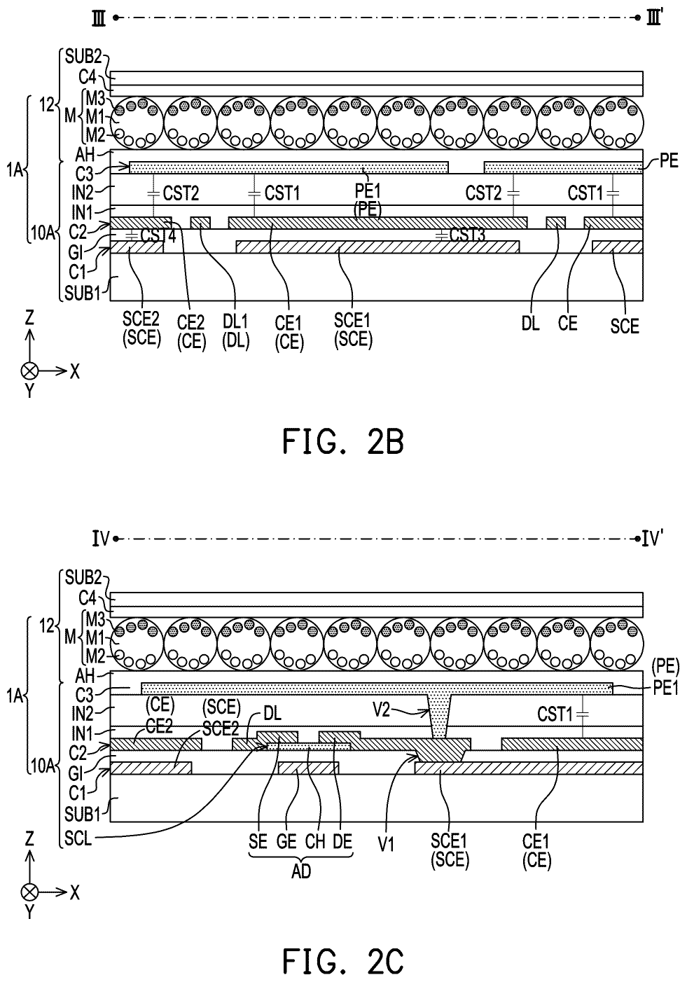

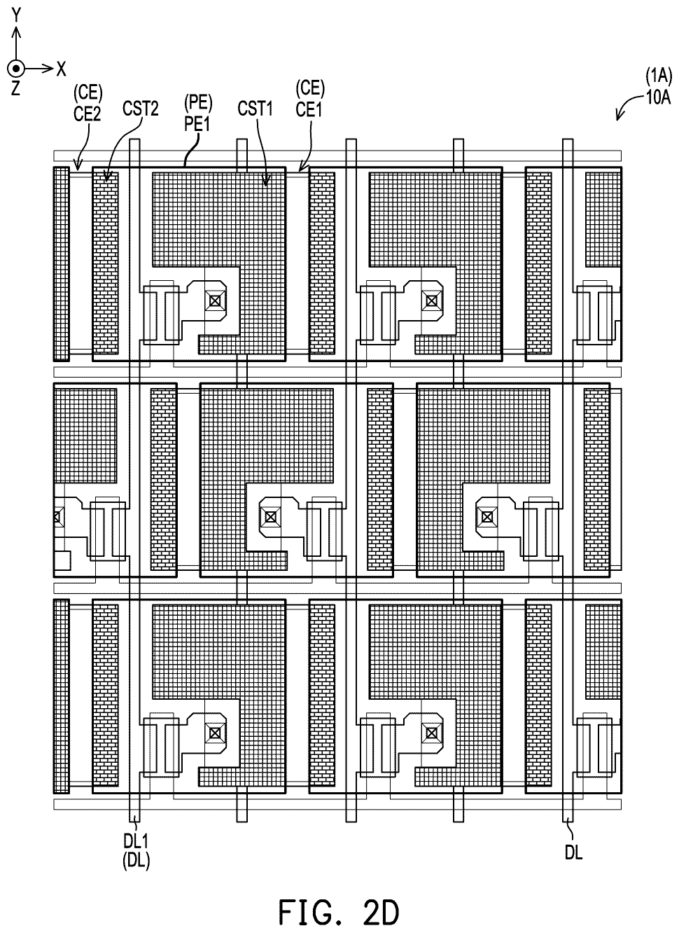

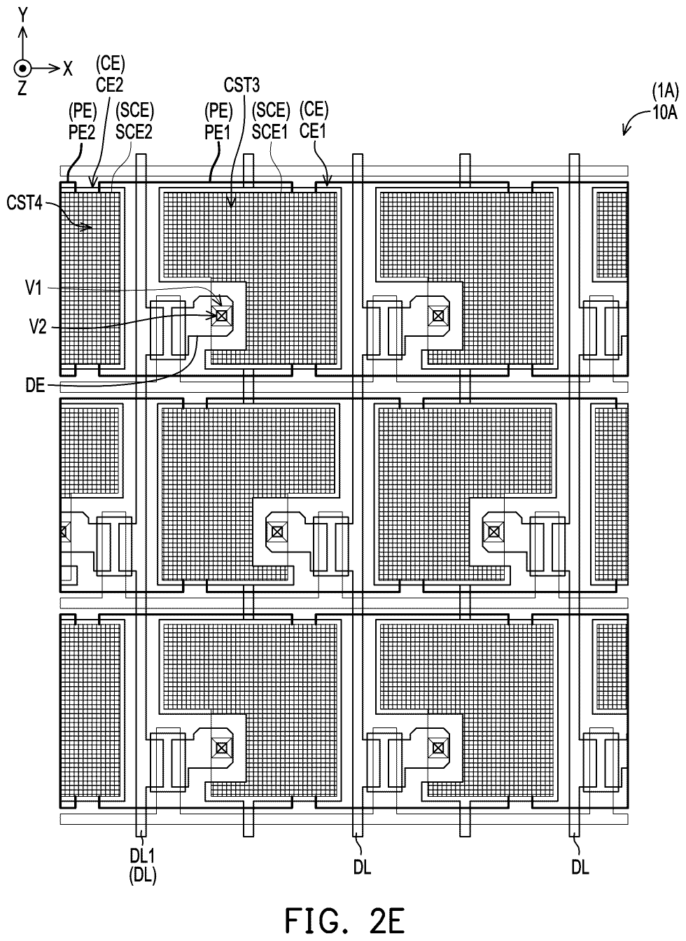

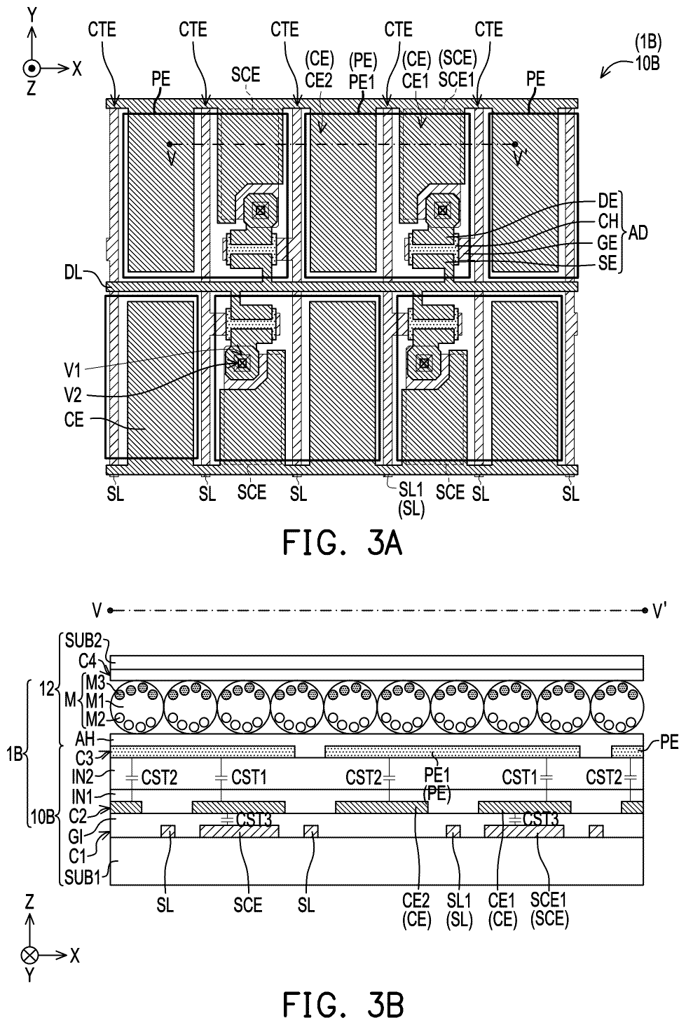

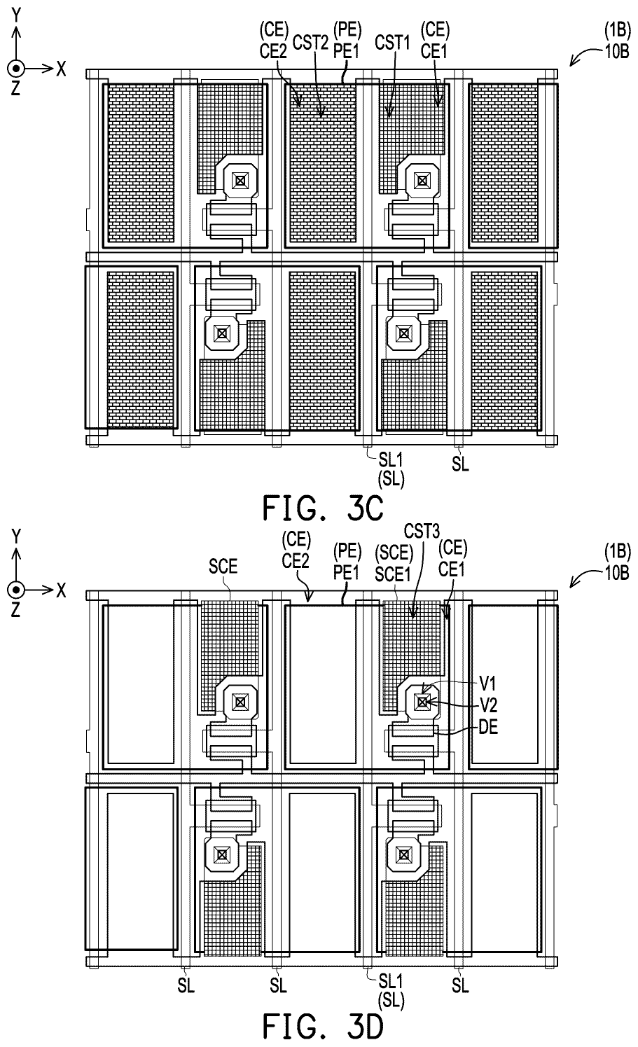

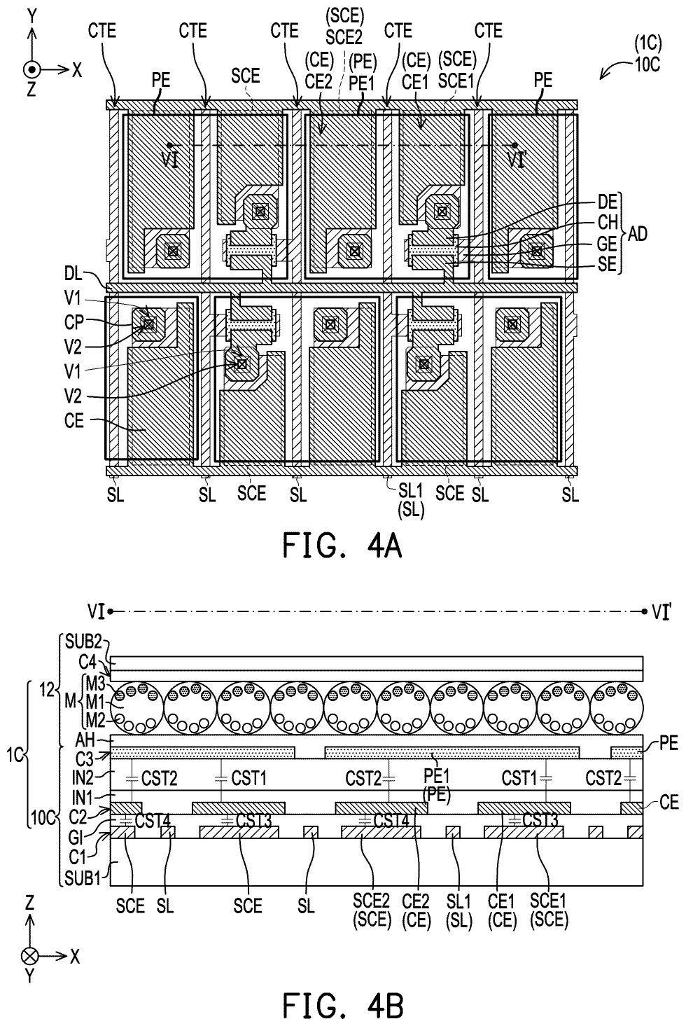

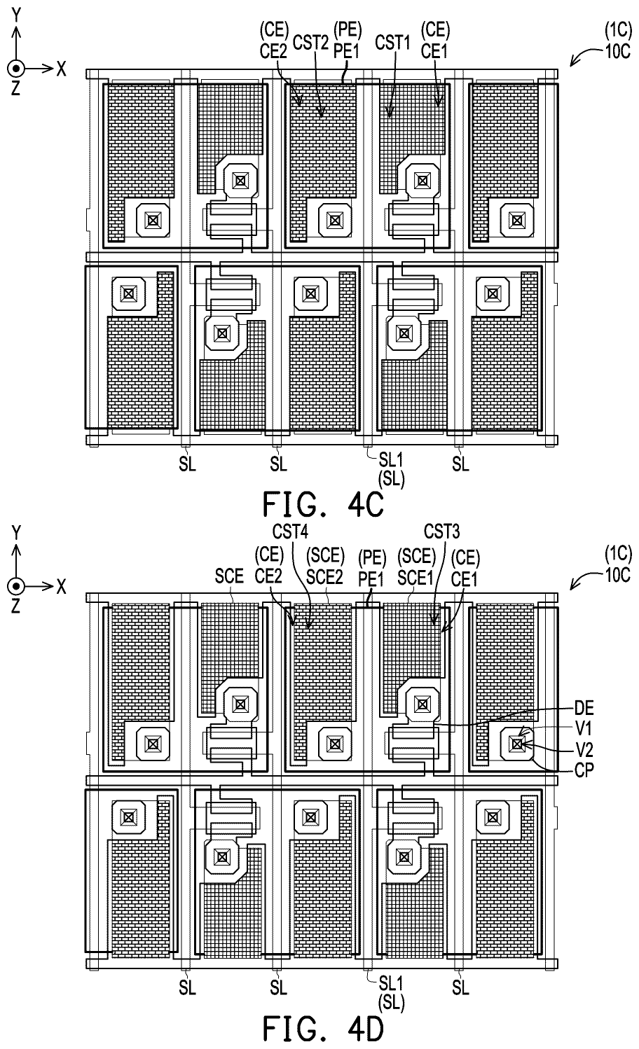

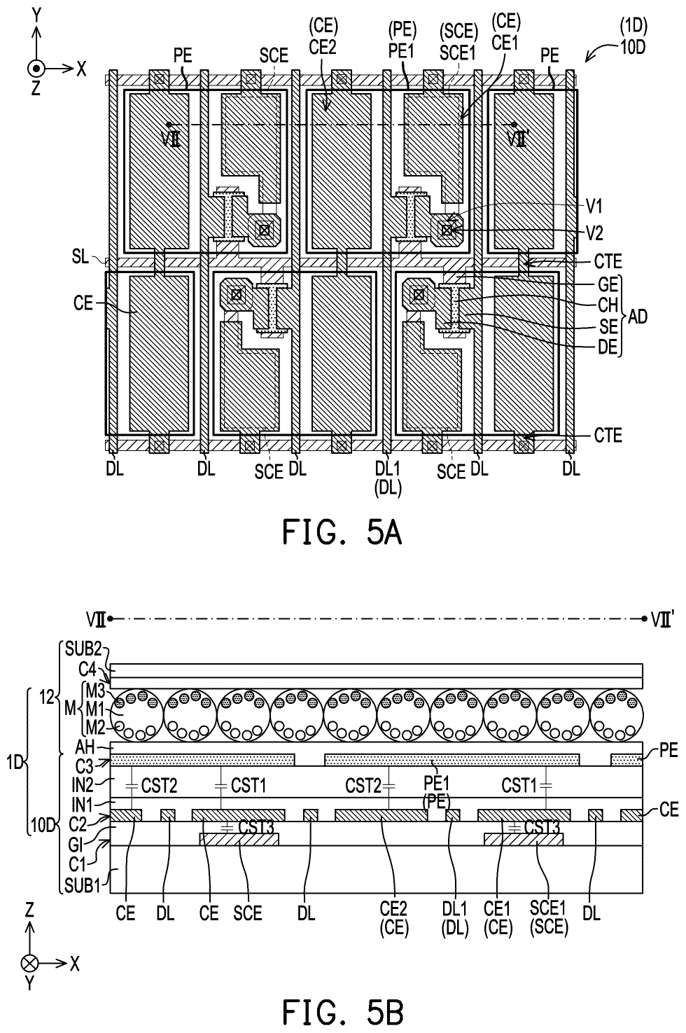

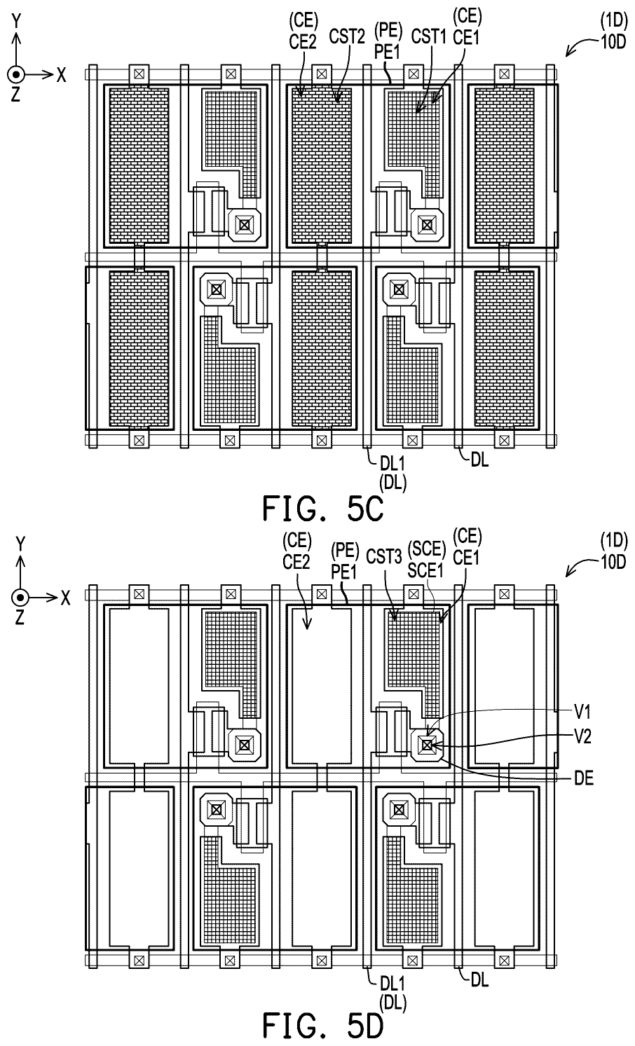

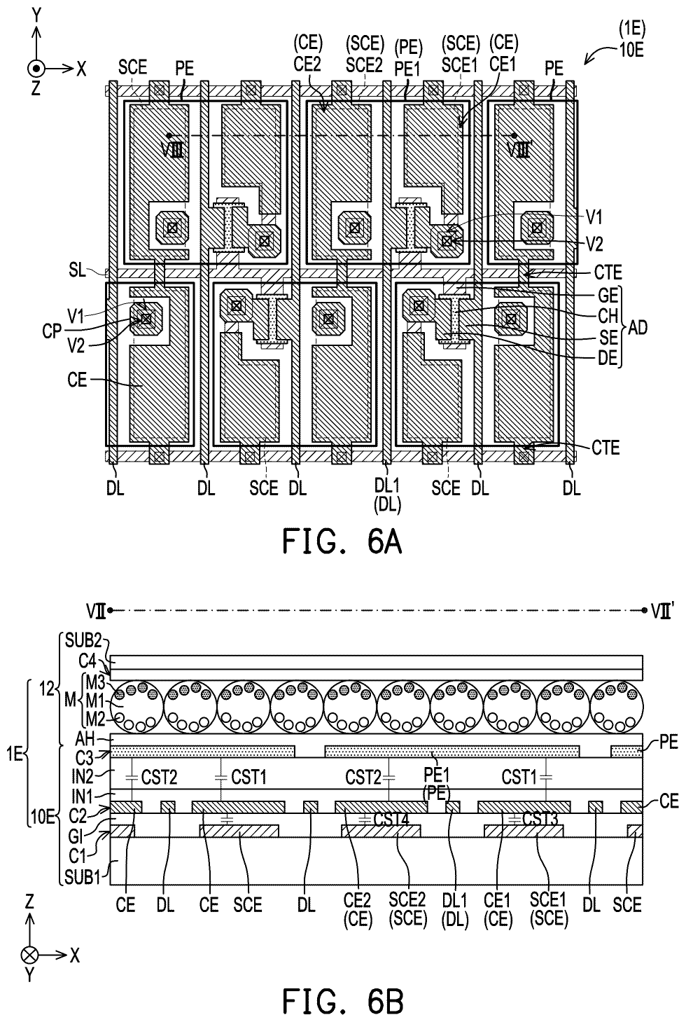

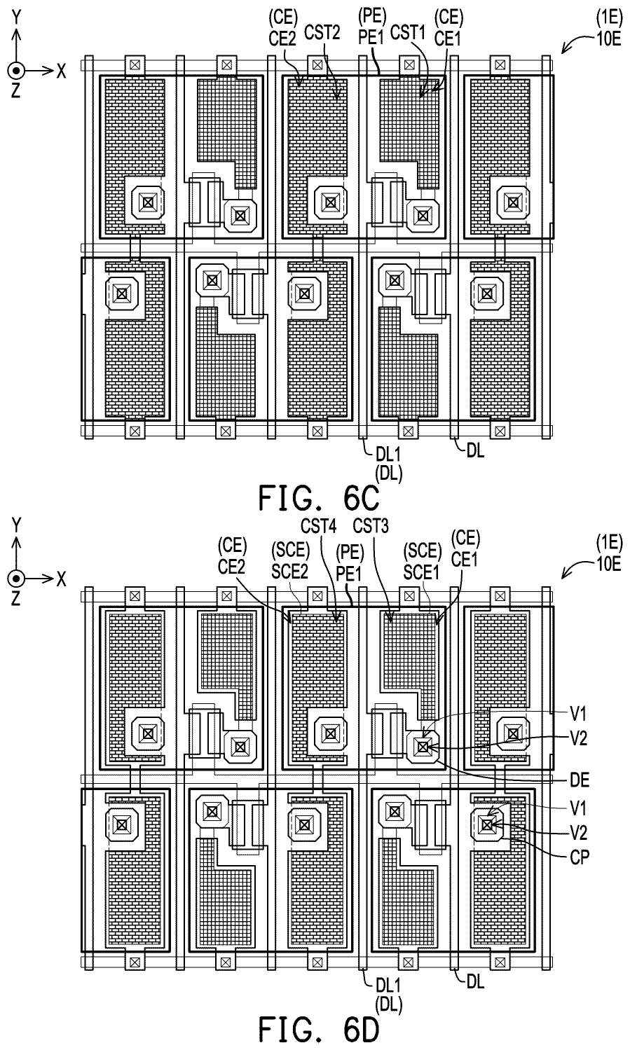

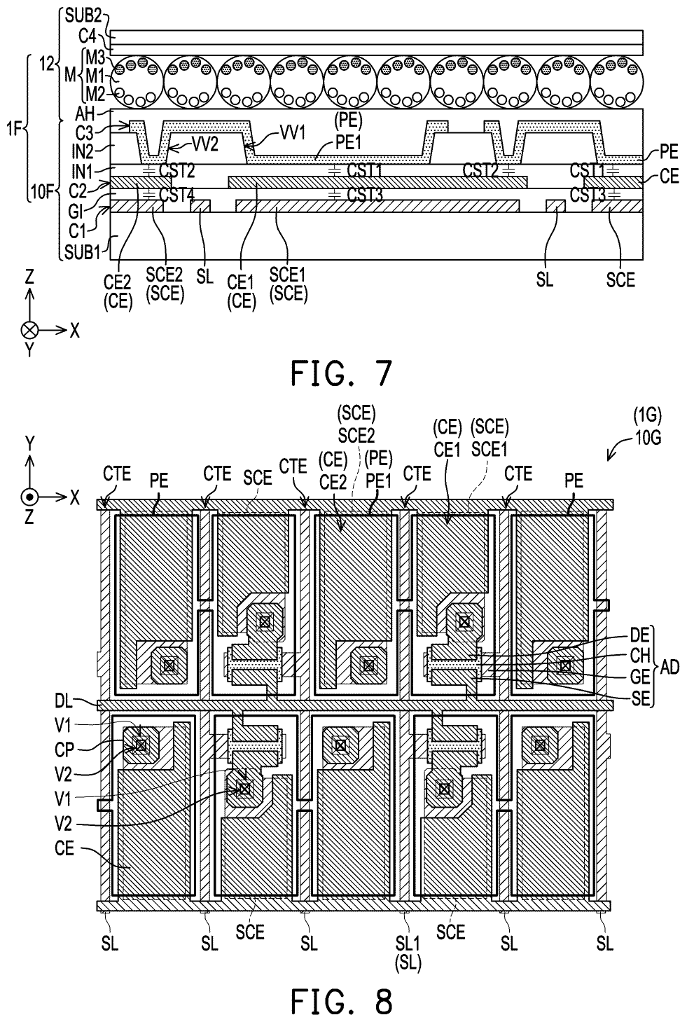

FIG. 1A, FIG. 2A, FIG. 3A, FIG. 4A, FIG. 5A, FIG. 6A, and FIG. 8 are partial top views of seven electrophoretic displays according to some embodiments of the disclosure, each of the drawings illustrates some elements and/or film layers of an element array substrate in an electrophoretic display, and an electrophoretic display substrate of the electrophoretic display is omitted in the drawings, so that relative disposition relationships of elements in the element array substrate are clearly indicated. FIG. 1B and FIG. 1C are schematic cross-sectional views corresponding to a section line I-I′ and a section line II-II′ in FIG. 1A respectively. FIG. 1D is a top view illustrating a first storage capacitor and a second storage capacitor in FIG. 1A. FIG. 1E is a top view illustrating a third storage capacitor and a fourth storage capacitor in FIG. 1A. FIG. 2B and FIG. 2C are schematic cross-sectional views corresponding to a section line III-III′ and a section line IV-IV′ in FIG. 2A respectively. FIG. 2D is a top view illustrating the first storage capacitor and the second storage capacitor in FIG. 2A. FIG. 2E is a top view illustrating the third storage capacitor and the fourth storage capacitor in FIG. 2A. FIG. 3B is a schematic cross-sectional view corresponding to a cross-section line V-V′ in FIG. 3A. FIG. 3C is a top view illustrating the first storage capacitor and the second storage capacitor in FIG. 3A. FIG. 3D is a top view illustrating a third storage capacitor in FIG. 3A. FIG. 4B is a schematic cross-sectional view corresponding to a section line VI-VI′ in FIG. 4A. FIG. 4C is a top view illustrating the first storage capacitor and the second storage capacitor in FIG. 4A. FIG. 4D is a top view illustrating the third storage capacitor and a fourth storage capacitor in FIG. 4A. FIG. 5B is a schematic cross-sectional view corresponding to a section line VII-VII′ in FIG. 5A. FIG. 5C is a top view illustrating the first storage capacitor and the second storage capacitor in FIG. 5A. FIG. 5D is a top view illustrating the third storage capacitor in FIG. 5A. FIG. 6B is a schematic cross-sectional view corresponding to a section line VIII-VIII′ in FIG. 6A. FIG. 6C is a top view illustrating the first storage capacitor and the second storage capacitor in FIG. 6A. FIG. 6D is a top view illustrating the third storage capacitor and the fourth storage capacitor in FIG. 6A. FIG. 7 is a partial cross-sectional schematic view of an electrophoretic display according to some embodiments of the disclosure. In the top view schematic views showing multiple storage capacitors, such as FIG. 1D, FIG. 1E, FIG. 2D, FIG. 2E, FIG. 3C, FIG. 3D, FIG. 4C, FIG. 4D, FIG. 5C, FIG. 5D, FIG. 6C, and FIG. 6D, shadings of elements or film layers other than the multiple storage capacitors is omitted, so that the storage capacitors are clearly indicated. In addition, in the top view schematic views, elements and/or film layers in the same conductive layer are drawn with lines of the same thickness, while elements and/or film layers in different conductive layers are drawn with lines of different thicknesses, so as to facilitate identification. For example, elements and/or film layers in a first conductive layer, a second conductive layer, and a third conductive layer are drawn with thin solid lines, general solid lines, and thick solid lines respectively.

Please refer to FIG. 1B together with FIG. 1C first. According to some embodiments of the disclosure, an electrophoretic display 1 may include an element array substrate 10 and an electrophoretic display substrate 12, but the disclosure is not limited thereto. According to different requirements, the electrophoretic display 1 may further include other elements or film layers.

In some embodiments, as shown in FIG. 1B and FIG. 1C, the element array substrate 10 may include a substrate SUB1, a conductive layer (also referred to as a first conductive layer) C1, a gate dielectric layer GI, a semiconductor layer SCL, a conductive layer (also referred to as a second conductive layer) C2, a dielectric layer (also referred to as a first dielectric layer) IN1, a dielectric layer (also referred to as a second dielectric layer) IN2, and a conductive layer (also referred to as a third conductive layer) C3, but the disclosure is not limited thereto. According to different requirements, one or more film layers may be added or removed from the element array substrate 10.

The substrate SUB1 may be a hard substrate or a flexible substrate, and a light transmittance property of the substrate SUB1 is not limited. That is to say, the substrate SUB1 may be a light-transmissive substrate, a semi-transparent substrate, or an opaque substrate. For example, the material of the substrate SUB1 may include glass, plastic, or other suitable materials. According to different requirements, the substrate SUB1 may also be an insulating film.

The conductive layer C1 is disposed on the substrate SUB1. The material of the conductive layer C1 may include opaque conductive materials, light-transmissive conductive materials, or combinations thereof. The opaque conductive material may include metals, alloys, or combinations thereof. The light-transmissive conductive material may include metal oxide, metal nitride, metal oxynitride, other suitable light-transmissive conductive materials, or a combination of the above. The metal oxide may include metal oxides such as indium tin oxide, indium zinc oxide, aluminum tin oxide, aluminum zinc oxide, or indium germanium zinc oxide, but the disclosure is not limited thereto.

The conductive layer C1 may be a patterned conductive layer and may include multiple gates GE (one gate GE is schematically shown in FIG. 1C), multiple scanning lines SL, and/or other conductive lines. For example, the conductive layer C1 may further include multiple storage capacitor electrodes SCE, but the disclosure is not limited thereto.

In some embodiments, as shown in FIG. 1A, the multiple scanning lines SL may be arranged along a direction X and extend along a direction Y. The direction X and the direction Y intersects each other, and are, for example, perpendicular to each other, but the disclosure is not limited thereto. Each gate GE may be electrically connected to a corresponding scanning line SL. In some embodiments, as shown in FIG. 1A, each gate GE extends away from the corresponding scanning line SL along the direction X or a reverse direction thereof from an edge of the corresponding scanning line SL. In some embodiments, as shown in FIG. 1A, the multiple gates GE arranged along the direction Y may be electrically connected to the same scanning line SL and alternately disposed on opposite sides (for example, left and right sides) of the electrically connected scanning line SL. The multiple storage capacitor electrodes SCE are arranged adjacent to the multiple gates GE and kept at a distance from the multiple gates GE to maintain independent electrical properties. The multiple storage capacitor electrodes SCE and the multiple scanning lines SL are, for example, alternately arranged along the direction X.

Referring again to FIG. 1B and FIG. 1C, the gate dielectric layer GI is disposed on the conductive layer C1 and the substrate SUB1. The material of the gate dielectric layer GI is, for example, an inorganic dielectric layer. For example, the material of the gate dielectric layer GI may include, for example, silicon oxide, silicon oxynitride, silicon nitride, or a combination thereof, but the disclosure is not limited thereto.

The semiconductor layer SCL is disposed on the gate dielectric layer GI. The material of the semiconductor layer SCL may include, for example, crystalline silicon, amorphous silicon, polycrystalline silicon, oxide semiconductor, organic semiconductor, in which the oxide semiconductor may include indium-gallium-zinc oxide (IGZO), zinc oxide (ZnO), tin oxide (SnO), indium-zinc oxide (IZO), gallium-zinc oxide (GZO), zinc-tin oxide (ZTO), or indium-tin oxide (ITO), but the disclosure is not limited thereto.

The semiconductor layer SCL may be a patterned semiconductor layer and may include a plurality of semiconductor patterns CH (one semiconductor pattern CH is schematically shown in FIG. 1C). The multiple semiconductor patterns CH may overlap the multiple gates GE in a direction Z respectively.

The conductive layer C2 is disposed on the semiconductor layer SCL and the gate dielectric layer GI. For the material of the conductive layer C2, reference may be made to the material of the conductive layer C1, so details will not be repeated here.

The conductive layer C2 may be a patterned conductive layer and may include multiple sources SE (one source SE is schematically shown in FIG. 1C), multiple drains DE (one drain DE is schematically shown in FIG. 1C), multiple data lines DL (one data line DL is schematically shown in FIG. 1C), and/or other conductive lines. For example, the conductive layer C2 may further include multiple common electrodes CE and multiple connection electrodes CTE (reference may be made to FIG. 1A), but the disclosure is not limited thereto.

In some embodiments, as shown in FIG. 1A, the multiple data lines DL may be arranged along the direction Y and extend along the direction X. Each source SE and a corresponding drain DE are positioned over and on opposite sides of a corresponding semiconductor pattern CH. Each source SE may be electrically connected to a corresponding data line DL, and each drain DE may be connected to a corresponding storage capacitor electrode SCE through a corresponding through hole V1 in the gate dielectric layer GI (reference may also be made to FIG. 1C). Each storage capacitor electrode SCE is, for example, surrounded by two adjacent scanning lines SL and two adjacent data lines DL, and each storage capacitor electrode SCE overlaps a corresponding common electrode CE in the direction Z. The multiple common electrodes CE are arranged adjacent to the multiple drains DE and kept at a distance from the multiple drains DE to maintain independent electrical properties. Each connection electrode CTE extends, for example, along the direction X and crosses a corresponding scanning line SL to electrically connect two adjacent common electrodes CE in the direction X. The width of the connection electrode CTE in the direction Y may be smaller than the width of the common electrode CE in the direction Y to reduce the parasitic capacitance from the scanning line SL.

In some embodiments, the element array substrate 10 may further include multiple active components AD. Each active component AD may include the gate GE, the semiconductor pattern CH, the source SE, and the drain DE, but the disclosure is not limited thereto. In some embodiments, as shown in FIG. 1A, the multiple active components AD may be arranged in a non-linear arrangement, such as a triangular arrangement, but the disclosure is not limited thereto. The active component AD in FIG. 1C is implemented by using a bottom gate thin film transistor as an example, but it should be understood that the type of the active component AD may be changed according to actual needs, and the disclosure is not limited thereto.

Referring again to FIG. 1B and FIG. 1C, the dielectric layer IN1 is disposed on the conductive layer C2, the semiconductor layer SCL, and the gate dielectric layer GI. The dielectric layer IN1 is, for example, an inorganic dielectric layer. For example, the material of the dielectric layer IN1 may include, for example, silicon oxide, silicon oxynitride, silicon nitride, or a combination thereof, but the disclosure is not limited thereto.

The dielectric layer IN2 is disposed on the dielectric layer IN1. The dielectric layer IN2 is, for example, a flat layer and may include an organic dielectric layer. For example, the material of the dielectric layer IN2 may include polyimide resin, epoxy resin, acrylic resin, or other polymer materials.

The conductive layer C3 is disposed on the dielectric layer IN2. For the material of the conductive layer C3, reference may be made to the material of the conductive layer C1, so details will not be repeated here. In some embodiments, the conductive layer C3 may be a stacked layer of metal and metal oxide to improve the adhesion of the conductive layer C3 to the dielectric layer IN2 (such as an organic dielectric layer), but the disclosure is not limited thereto.

The conductive layer C3 may be a patterned conductive layer and may include multiple pixel electrodes PE and/or other conductive lines. In some embodiments, as shown in FIG. 1A, the multiple pixel electrodes PE may be arranged in a non-linear arrangement. For example, the multiple pixel electrodes PE may be aligned with each other in the direction X and staggered in the direction Y, like a triangular arrangement. Alternatively, although not shown in FIG. 1A, the multiple pixel electrodes PE may be aligned with each other in the direction Y and staggered in the direction X. A pixel array of a triangular arrangement is achieved by arranging the multiple pixel electrodes PE in a triangular arrangement, which can improve image quality or reduce the stripe pattern phenomenon of the image. In some embodiments, each pixel electrode PE may be electrically connected to a corresponding drain DE through a through hole V2 (reference may be made to FIG. 1A or FIG. 1C) penetrating the dielectric layer IN2 and the dielectric layer IN1.

Referring again to FIG. 1B and FIG. 1C, the electrophoretic display substrate 12 is disposed on the element array substrate 10 and is closer to an light incident side of the electrophoretic display 1 than the element array substrate 10 (for example, when a user is viewing an image, the electrophoretic display 1 faces a side of the user). In some embodiments, as shown in FIG. 1B and FIG. 1C, the electrophoretic display substrate 12 may include a substrate SUB2, a conductive layer C4, an electrophoretic layer M, and an adhesive layer AH, but the disclosure is not limited thereto. According to different requirements, one or more film layers may be added or removed from the electrophoretic display substrate 12.

The substrate SUB2 may be a hard substrate or a flexible substrate, and the substrate SUB2 is a light-transmissive substrate to reduce shielding or absorption of a light beam. For example, the material of the substrate SUB2 may include glass, plastic, or other suitable materials. According to different requirements, substrate SUB2 may also be an insulating film.

The conductive layer C4 is disposed on a surface of the substrate SUB2 facing the element array substrate 10. The material of the conductive layer C4 may include light-transmissive conductive materials. In addition, the conductive layer C4 may be an entire surface of a conductive layer, but the disclosure is not limited thereto.

The electrophoretic layer M is disposed on the surface of the conductive layer C4 facing the element array substrate 10. For example, the electrophoretic layer M may include an electrophoresis liquid M1, a plurality of white electrophoresis particles M2, and a plurality of black electrophoresis particles M3, but the disclosure is not limited thereto. The electrophoresis liquid M1 is, for example, transparent. The plurality of white electrophoretic particles M2 and the plurality of black electrophoretic particles M3 are distributed in the electrophoretic liquid M1, and the plurality of white electrophoretic particles M2 and the plurality of black electrophoretic particles M3 may have opposite electrical properties. In this way, by changing the voltage applied to the pixel electrode PE and the conductive layer C4, or by changing the voltage or drive waveform applied to the pixel electrode PE while the voltage of the conductive layer C4 is fixed, the distribution of the multiple white electrophoretic particles M2 and the multiple black electrophoretic particles M3 is controlled, thereby the image displayed by the electrophoretic display 1 is controlled. Although FIG. 1B and FIG. 1C show that the electrophoretic layer M has a microcapsule structure, the disclosure is not limited thereto. In other embodiments, the electrophoretic layer M may have a microcup structure. In addition, the electrophoresis liquid M1 in the electrophoretic layer M may be a colored or transparent electrophoresis liquid, and charged particles of one color or multiple colors may be distributed in the electrophoresis liquid M1.

The adhesive layer AH is disposed between the electrophoretic layer M and the conductive layer C3, and the electrophoretic display substrate 12 may be fixed to the element array substrate 10 through the adhesive layer AH. The adhesive layer AH is, for example, an insulating adhesive layer and may be an insulating organic adhesive layer, but the disclosure is not limited thereto. For example, the adhesive layer AH may be optically clear adhesive (OCA), optically clear resin (OCR), or other suitable adhesive materials.

In this embodiment, any two adjacent common electrodes CE are respectively disposed on opposite sides (for example, left and right sides) of one signal line (such as the scanning line SL) among multiple signal lines (including the multiple scanning lines SL and the multiple data lines DL). One pixel electrode (such as a pixel electrode PE1) among the plurality of pixel electrodes PE crosses the one signal line (such as the scanning line SL) and forms two storage capacitors with the two adjacent common electrodes CE respectively. Take FIG. 1A and FIG. 1D as examples, a first common electrode CE1 and a second common electrode CE2 among the multiple common electrodes CE are respectively disposed on opposite sides (for example, left and right sides) of one signal line (such as a scanning line SL1) among multiple signal lines (including the multiple scanning lines SL and the multiple data lines DL). One pixel electrode PE1 among the plurality of pixel electrodes PE crosses the one signal line (such as the scanning line SL1) and forms a first storage capacitor CST1 and a second storage capacitor CST2 with the first common electrode CE1 and the second common electrode CE2 respectively. FIG. 1D shows the first storage capacitor CST1 and the second storage capacitor CST2 with different shadings to facilitate identification.

Compared with the multiple scanning lines SL bypassing the multiple pixel electrodes PE, through the multiple scanning lines SL directly crossing the multiple pixel electrodes PE instead of bypassing the multiple pixel electrodes PE, the scanning line SL may have a shorter length, thereby the impedance is lower, and the RC loading is lower. In addition, the pixel electrode PE and the two adjacent common electrodes CE form the two storage capacitors respectively to increase the storage capacitance value, which can meet the demand for the electrophoretic display to have a large storage capacitance value, thereby facilitates to alleviate a problem of properties such as the size, resolution, or pixel density of the pixel array in a triangular arrangement being more limited than the conventional pixel array.

In some embodiments, as shown in FIG. 1D, the one signal line crossed by the pixel electrode PE1 is, for example, the scanning line SL (such as the scanning line SL1), and extending directions (such as the direction Y) of the second storage capacitor CST2 and the one signal line (such as the scanning line SL1) are the same. In some embodiments, as shown in FIG. 1D, the quantity of the first storage capacitors CST1 in the element array substrate 10 may be plural, the quantity of the second storage capacitors CST2 in the element array substrate 10 may be plural, and the multiple first storage capacitors CST1 and the multiple second storage capacitors CST2 may be arranged alternately along a direction (such as the direction X) perpendicular to the extending direction (such as the direction Y) of the scanning line SL1.

In some embodiments, as shown in FIG. 1A, FIG. 1B, and FIG. 1E, the element array substrate 10 may further include the multiple storage capacitor electrodes SCE, and the multiple pixel electrodes PE and the multiple storage capacitor electrodes SCE may be respectively positioned on opposite sides (for example, upper and lower sides) of the multiple common electrodes CE, and the first storage capacitor electrode SCE1 among the plurality of storage capacitor electrodes SCE may overlap the first common electrode CE1 and form a third storage capacitor CST3 with the first common electrode CE1. In some embodiments, as shown in FIG. 1B and FIG. 1C, the first storage capacitor electrode SCE1 may be electrically connected to the pixel electrode PE1 crossing the scanning line SL1. For example, the first storage capacitor electrode SCE1 may be electrically connected to the pixel electrode PE1 through a corresponding through hole V1, a corresponding through hole V2, and a corresponding drain DE.

In some embodiments, as shown in FIG. 1A, FIG. 1B, and FIG. 1E, the second storage capacitor electrode SCE2 among the plurality of storage capacitor electrodes SCE may overlap the second common electrode CE2 and form a fourth storage capacitor CST4 with the second common electrode CE2. In some embodiments, as shown in FIG. 1E, the second storage capacitor electrode SCE2 may be electrically connected to another pixel electrode (such as a pixel electrode PE2) adjacent to the pixel electrode PE1 among the plurality of pixel electrodes PE. For example, the second storage capacitor electrode SCE2 may be electrically connected to the pixel electrode PE2 through a corresponding through hole V1, a corresponding through hole V2, and a corresponding drain DE.

Through the multiple storage capacitor electrodes SCE and the multiple common electrodes CE respectively forming the multiple storage capacitors (reference may be made to shaded areas in FIG. 1E), the storage capacitance value can be further improved to meet the demand for the electrophoretic display to have a large storage capacitance value.

Please refer to FIG. 2A to FIG. 2E. The main difference between an electrophoretic display 1A and the electrophoretic display 1 of FIG. 1A to FIG. 1E lies in disposition relationships of elements in an element array substrate 10A. In detail, in the element array substrate 10A, the multiple scanning lines SL are arranged along the direction Y and extend along the direction X. For example, each gate GE extends from the edge of the corresponding scanning line SL along the direction Y away from the corresponding scanning line SL. In addition, the multiple gates GE arranged along the direction X may be electrically connected to the same scanning line SL and disposed on the same side (for example, an upper side) of the electrically connected scanning line SL. The multiple data lines DL are arranged along the direction X and extend along the direction Y. The multiple sources SE arranged along the direction Y may be electrically connected to the same data line DL and alternately disposed on opposite sides (for example, left and right sides) of the electrically connected data line DL. Each connection electrode CTE extends, for example, along the direction Y and crosses a corresponding scanning line SL to electrically connect two adjacent common electrodes CE in the direction Y. The width of the connection electrode CTE in the direction X may be smaller than the width of common electrode CE in the direction X to reduce the parasitic capacitance from the scanning line SL.

In this embodiment, any two adjacent common electrodes CE are respectively disposed on opposite sides (for example, left and right sides) of one signal line (such as the data line DL) among multiple signal lines (including the multiple scanning lines SL and the multiple data lines DL). One pixel electrode (such as the pixel electrode PE1) among the plurality of pixel electrodes PE crosses the one signal line (such as the data line DL) and forms two storage capacitors with the two adjacent common electrodes CE respectively. Take FIG. 2A and FIG. 2D as examples, the first common electrode CE1 and the second common electrode CE2 among the multiple common electrodes CE are respectively disposed on opposite sides (for example, left and right sides) of one signal line (such as a data line DL1) among the multiple signal lines (including the multiple scanning lines SL and the multiple data lines DL). One pixel electrode PE1 among the plurality of pixel electrodes PE crosses the one signal line (such as the data line DL1) and forms the first storage capacitor CST1 and the second storage capacitor CST2 with the first common electrode CE1 and the second common electrode CE2 respectively.

Compared with multiple data lines DL bypassing the multiple pixel electrodes PE, through the multiple data lines DL directly crossing the multiple pixel electrodes PE without bypassing the multiple pixel electrodes PE, the data line DL may have a shorter length, thereby the impedance is lower, and the RC loading is lower. In addition, the pixel electrode PE and the two adjacent common electrode CE form the two storage capacitors respectively to increase the storage capacitance value, which can meet the demand for the electrophoretic display to have a large storage capacitance value, thereby facilitates to alleviate a problem of properties such as the size, resolution, or pixel density of the pixel array in a triangular arrangement being more limited than the conventional pixel array.

In some embodiments, as shown in FIG. 2D, the one signal line crossed by the pixel electrode PE1 is, for example, the data line DL (such as the data line DL1), and extending directions (such as the direction Y) of the second storage capacitor CST2 and the one signal line (such as the data line DL1) are the same. In some embodiments, as shown in FIG. 2D, the quantity of the first storage capacitor CST1 in the element array substrate 10 may be plural, the quantity of the second storage capacitor CST2 in the element array substrate 10 may be plural, and the multiple first storage capacitors CST1 and the multiple second storage capacitors CST2 may be arranged alternately along a direction (such as the direction X) perpendicular to the extending direction (such as the direction Y) of the data line DL1.

Please refer to FIG. 3A to FIG. 3D. The main difference between an electrophoretic display 1B and the electrophoretic display 1 of FIG. 1A to FIG. 1E is that an element array substrate 10B adopts a half-source driving (HSD) design. In detail, in the element array substrate 10B, the multiple sources SE arranged along the direction X form a source row, and two adjacent source rows in the direction Y are electrically connected to the same data line DL. That is, the two adjacent source rows in the direction Y share the same data line DL. Through this design, the quantity of the data lines DL can be reduced, which facilitates expansion of storage capacitance. In some embodiments, the multiple gates GE electrically connected to the same scanning line SL are, for example, positioned on the same side of the electrically connected scanning line SL, and the multiple gates GE arranged along the direction Y are positioned between two adjacent scanning lines SL and alternately electrically connected to the two adjacent scanning lines SL.

In some embodiments, as shown in FIG. 3A and FIG. 3D, between two adjacent active components AD arranged in the direction X, there may be no storage capacitor electrode SCE disposed, but the disclosure is not limited thereto.

Please refer to FIG. 4A to FIG. 4D. The main difference between an electrophoretic display 1C and the electrophoretic display 1B of FIG. 3A to FIG. 3D lies in disposition relationships of elements in an element array substrate 10C. In detail, in the element array substrate 10C, between two adjacent active components AD arranged in the direction X, there is the storage capacitor electrode SCE disposed, such as the second storage capacitor electrode SCE2, and the second storage capacitor electrode SCE2 and the second common electrode CE2 form the fourth storage capacitor CST4. In some embodiments, as shown in FIG. 4A, the second storage capacitor electrode SCE2 and the first storage capacitor electrode SCE1 may be electrically connected to the same pixel electrode (such as the pixel electrode PE1). For example, the first storage capacitor electrode SCE1 may be electrically connected to the pixel electrode PE1 through a corresponding through hole V1, a corresponding through hole V2, and a corresponding drain DE, and the second storage capacitor electrode SCE2 may be electrically connected to the pixel electrode PE1 through a corresponding through hole V1, a corresponding through hole V2, and a corresponding conductive part CP. The conductive part CP belongs to, for example, the second conductive layer (for example, the conductive layer C2), and the conductive part CP is kept at a distance from the common electrode CE to maintain independent electrical properties.

Please refer to FIG. 5A to FIG. 5D. The main difference between an electrophoretic display 1D and the electrophoretic display 1A of FIG. 2A to FIG. 2E is that an element array substrate 10D adopts a half-gate driving (HGD) design. In detail, in the element array substrate 10D, the multiple gates GE arranged along the direction X form a gate row, and two adjacent gate rows in the direction Y are electrically connected to the same scanning line SL. That is, the two adjacent gate rows in the direction Y share the same scanning line SL. Through this design, the quantity of the scanning lines SL can be reduced, which facilitates expansion of storage capacitance. In some embodiments, the multiple sources SE electrically connected to the same data line DL are, for example, positioned on the same side of the electrically connected data line DL, and the multiple sources SE arranged along the direction Y are positioned between two adjacent data lines DL and alternately electrically connected to the two adjacent data lines DL.

In some embodiments, as shown in FIG. 5A and FIG. 5D, between two adjacent active components AD arranged in the direction X, there may be no storage capacitor electrode SCE disposed, but the disclosure is not limited thereto.

Please refer to FIG. 6A to FIG. 6D. The main difference between an electrophoretic display 1E and the electrophoretic display 1D of FIG. 5A to FIG. 5D lies in disposition relationships of elements in an element array substrate 10E. In detail, in the element array substrate 10E, between two adjacent active components AD arranged in the direction X, there is the storage capacitor electrode SCE disposed, such as second storage capacitor electrode SCE2, and the second storage capacitor electrode SCE2 and the second common electrode CE2 form the fourth storage capacitor CST4. In some embodiments, as shown in FIG. 6A, the second storage capacitor electrode SCE2 and the first storage capacitor electrode SCE1 may be electrically connected to the same pixel electrode (such as the pixel electrode PE1). For example, the first storage capacitor electrode SCE1 may be electrically connected to the pixel electrode PE1 through a corresponding through hole V1, a corresponding through hole V2, and a corresponding drain DE, and the second storage capacitor electrode SCE2 may be electrically connected to the pixel electrode PE1 through a corresponding through hole V1, a corresponding through hole V2, and a corresponding conductive part CP. The conductive part CP belongs to, for example, the second conductive layer (for example, the conductive layer C2), and the conductive part CP is kept at a distance from the common electrode CE to maintain independent electrical properties.

Referring to FIG. 7, the main difference between an electrophoretic display 1F and the electrophoretic display 1 of FIG. 1B lies in disposition relationships of elements in an element array substrate 10F. In detail, in the element array substrate 10F, the dielectric layer IN2 has a first through hole VV1 overlapping the first common electrode CE1 and a second through hole VV2 overlapping the second common electrode CE2, and the pixel electrode PE1 crossing the scanning line SL is further disposed in the first through hole VV1 and the second through hole VV2.

By removing a portion of the dielectric layer IN2 positioned on the first common electrode CE1 and the second common electrode CE2, the distance between the pixel electrode PE1 and the first common electrode CE1 and the distance between the pixel electrode PE1 and the second common electrode CE2 are reduced, which can further improve storage capacitance values of the first storage capacitor CST1 and the second storage capacitor CST2. Although FIG. 7 is modified from the structure of FIG. 1B, it should be understood that any embodiment of the disclosure may be modified as described above.

Please refer to FIG. 8. The main difference between an electrophoretic display 1G and the electrophoretic display 1C of FIG. 4A lies in disposition relationships of elements in an element array substrate 10G. In detail, in the element array substrate 10G, the width of the pixel electrode PE (such as the pixel electrode PE1) overlapping the one signal line crossed (such as the scanning line SL1) is smaller than the width of the remaining part of the pixel electrode PE (such as the pixel electrode PE1). By removing at least part of the pixel electrode PE (such as the pixel electrode PE1) crossing the signal line (such as the scanning line SL1), the parasitic capacitance from the signal line (such as the scanning line SL1) can be reduced. Although FIG. 8 is modified from the structure of FIG. 1G, it should be understood that any embodiment of the disclosure may be modified as described above.

In summary, in the embodiments of the disclosure, through the multiple signal lines directly crossing the multiple pixel electrodes instead of bypassing the multiple pixel electrodes, the multiple signal lines may have shorter lengths, thereby the impedance is lower, and the RC loading is lower. In addition, the pixel electrode and the two adjacent common electrodes form the two storage capacitors respectively to increase the storage capacitance value, which can meet the demand for the electrophoretic display to have a large storage capacitance value, thereby facilitates to alleviate a problem of properties such as the size, resolution, or pixel density of pixel arrays arranged in a non-linear arrangement (for example, a triangular arrangement) being more limited than the conventional pixel array.

Although the disclosure has been disclosed above through embodiments, the embodiments are not intended to limit the disclosure. Persons with ordinary knowledge in the relevant technical field may make some changes and modifications without departing from the spirit and scope of the disclosure. Therefore, the protection scope of the disclosure shall be determined by the appended claims.

What is claimed is:

1. An electrophoretic display, comprising:
an element array substrate, comprising a plurality of signal lines, a plurality of common electrodes, and a plurality of pixel electrodes, wherein a first common electrode and a second common electrode among the plurality of common electrodes are respectively disposed on opposite sides of one signal line among the plurality of signal lines, and one pixel electrode among the plurality of pixel electrodes crosses the one signal line and forms a first storage capacitor and a second storage capacitor with the first common electrode and the second common electrode respectively; and
an electrophoretic display substrate, disposed on the element array substrate.

2. The electrophoretic display as claimed in claim 1, wherein the one signal line is a scanning line or a data line, and extending directions of the second storage capacitor and the one signal line are same.

3. The electrophoretic display as claimed in claim 1, wherein the element array substrate further comprises a plurality of storage capacitor electrodes, the plurality of pixel electrodes and the plurality of storage capacitor electrodes are respectively positioned on opposite sides of the plurality of common electrodes, and a first storage capacitor electrode among the plurality of storage capacitor electrodes overlaps the first common electrode and forms a third storage capacitor with the first common electrode.

4. The electrophoretic display as claimed in claim 3, wherein the first storage capacitor electrode is electrically connected to the one pixel electrode.

5. The electrophoretic display as claimed in claim 3, wherein a second storage capacitor electrode among the plurality of storage capacitor electrodes overlaps the second common electrode and forms a fourth storage capacitor with the second common electrode.

6. The electrophoretic display as claimed in claim 5, wherein the second storage capacitor electrode is electrically connected to another pixel electrode adjacent to the one pixel electrode among the plurality of pixel electrodes.

7. The electrophoretic display as claimed in claim 5, wherein the second storage capacitor electrode is electrically connected to the one pixel electrode.

8. The electrophoretic display as claimed in claim 1, wherein the plurality of common electrodes belong to a second conductive layer, the plurality of pixel electrodes belong to a third conductive layer, the element array substrate further comprises a first dielectric layer and a second dielectric layer disposed sequentially on the second conductive layer, the third conductive layer is disposed on the second dielectric layer, the second dielectric layer has a first through hole overlapping the first common electrode and a second through hole overlapping the second common electrode, and the one pixel electrode is further disposed in the first through hole and the second through hole.

9. The electrophoretic display as claimed in claim 1, wherein a width of the one pixel electrode overlapping the one signal line is smaller than a width of the remaining part of the one pixel electrode.

10. The electrophoretic display as claimed in claim 1, wherein a quantity of the first storage capacitors in the element array substrate is plural, a quantity of the second storage capacitors in the element array substrate is plural, and the plurality of first storage capacitors and the plurality of second storage capacitors are alternately arranged along a direction perpendicular to an extending direction of the one signal line.

11. The electrophoretic display as claimed in claim 1, wherein the plurality of pixel electrodes are aligned with each other in a first direction and staggered in a second direction.
